(19) United States
(12) Patent Application Publication
(10) Pub. No.: US 2026/0008608 A1
(43) Pub. Date: Jan. 8, 2026

(54) SYSTEMS INCLUDING A CONTAINER, CABLES, AND NETWORK ACCESS EQUIPMENT FOR COMMUNICATIONS EQUIPMENT INSTALLATION AND ASSOCIATED METHODS

(71) Applicant: Novate Systems LLC, Raleigh, NC (US)

(72) Inventors: Otis James Johnston, Raleigh, NC (US); Phong Pham, Hickory, NC (US); Roger A. Hine, San Jose, CA (US); Christa Johnston, Raleigh, NC (US)

(21) Appl. No.: 19/256,026

(22) Filed: Jun. 30, 2025

Related U.S. Application Data
(60) Provisional application No. 63/667,047, filed on Jul. 2, 2024.

(51) Int. Cl. B65D 85/04; B65H 55/04

(52) U.S. Cl. CPC B65D 85/04; B65H 55/046

(57) ABSTRACT

Systems including a container, cables, and network access equipment for communications equipment installation and associated methods are disclosed. According to an aspect, a container defines an interior space and includes a first side and a second side that at least partially encloses the interior space. The first side defines a first opening. The second side defines a second opening. A first removable cover that at least partially covers the first opening. A second removable cover that at least partially covers the second opening. A communications cable includes a first end and a second end. The communications cable is positioned within the interior space such that the first end is positioned adjacent the first opening for access through the first opening. The network access equipment and/or the second end of the communications cable are removably affixed to the second removable cover.

### CROSS-REFERENCE TO RELATED APPLICATION

This application claims priority to U.S. Provisional Patent Application No. 63/667,047, filed Jul. 2, 2024, and titled “Pre-connected and factory certified optical network link in a customized box for easy payoff”, the content of which is incorporated herein by reference in its entirety.

### BACKGROUND

Communication equipment service providers or technicians perform a variety of tasks related to installing, maintaining, and repairing communication systems in commercial buildings and residences. Installation can involve running cables across a property to a building in order to connect a network access point (NAP) to a terminal at the building. Further, the installation can involve placement and connection of the terminal access by equipment within the building.

In the case of fiber internet installation, traditional techniques for connecting the NAP to an optical network terminal/unit (ONT/U) involves field splicing or field terminations which require highly skilled labor and specialized tools. These techniques increase time, cost, and equipment performance issues. Pre-terminated cables can reduce some of these concerns but still create performance issues due to exposure to weather elements when connecting devices. In both cases, service providers or technicians (e.g., fiber internet service providers (FISPs)) must test and certify the NAP to ONT link in the field. Lastly, FISPs rely on traditional spools to payout cable which inherently requires two or more installers to be onsite and frequently results in tangled, kinked, or twisted cables.

In view of the foregoing, there is a continuing need for improved equipment and techniques for installing communication cables and equipment, particularly fiber internet cables and equipment, for reducing times, costs, and equipment performance issues.

### SUMMARY OF THE DISCLOSURE

The presently disclosed subject matter relates to systems including a container, cables, and network access equipment for communications equipment installation and associated methods. According to an aspect, a container defines an interior space and includes a first side and a second side that at least partially encloses the interior space. The first side defines a first opening. The second side defines a second opening. A first removable cover that at least partially covers the first opening. A second removable cover that at least partially covers the second opening. A communications cable includes a first end and a second end. The communications cable is positioned within the interior space such that the first end is positioned adjacent the first opening for access through the first opening. The system also includes network access equipment configured for connection to the second end. The network access equipment and/or the second end of the communications cable are removably affixed to the second removable cover such that the network access equipment and/or the second end of the communications cable are accessible when the second removable cover is removed from the second opening.

### BRIEF DESCRIPTION OF DRAWINGS

Having thus described the presently disclosed subject matter in general terms, reference will now be made to the accompanying Drawings, which are not necessarily drawn to scale, and wherein:

FIG. 1 is a front perspective view of a system for communications equipment installation in accordance with embodiments of the present disclosure;

FIG. 2 is another front perspective view of the container shown in FIG. 1 with the cover removed and positioned apart from the container for access to the interior space;

FIG. 3 is a rear perspective view of the container shown in FIG. 1 with the cover removed and positioned apart from the container for access to the interior space;

FIG. 4 is another rear perspective view of the container as shown in FIG. 3 except with an end of the cable extending through the opening;

FIG. 5 is a front perspective view of a system for communications equipment installation in accordance with embodiments of the present disclosure;

FIG. 6 is a rear view of the system shown in FIG. 5;

FIG. 7 is a top view of a cardboard cutout that can be folded to form the container shown in FIGS. 5 and 6;

FIG. 8 is a block diagram of an example optical distribution network where a system in accordance with embodiments of the present disclosure can be installed;

FIG. 9 is a diagram depicting use of a system in accordance with embodiments for connecting a home to fiber-based Internet; and

FIG. 10 is a diagram showing element of a link to be certified.

### DETAILED DESCRIPTION OF THE DISCLOSURE

The following detailed description is made with reference to the figures. Exemplary embodiments are described to illustrate the disclosure, not to limit its scope, which is defined by the claims. Those of ordinary skill in the art will recognize a number of equivalent variations in the description that follows.

Articles “a” and “an” are used herein to refer to one or to more than one (i.e. at least one) of the grammatical object of the article. By way of example, “an element” means at least one element and can include more than one element.

“About” is used to provide flexibility to a numerical endpoint by providing that a given value may be “slightly above” or “slightly below” the endpoint without affecting the desired result.

The use herein of the terms “including,” “comprising,” or “having,” and variations thereof is meant to encompass the elements listed thereafter and equivalents thereof as well as additional elements. Embodiments recited as “including,” “comprising,” or “having” certain elements are also contemplated as “consisting essentially of” and “consisting” of those certain elements.

Recitation of ranges of values herein are merely intended to serve as a shorthand method of referring individually to each separate value falling within the range, unless otherwise indicated herein, and each separate value is incorporated into the specification as if it were individually recited herein. For example, if a range is stated as between 1%-50%, it is intended that values such as between 2%-40%, 10%-30%, or 1%-3%, etc. are expressly enumerated in this specification. These are only examples of what is specifically intended, and all possible combinations of numerical values between and including the lowest value and the highest value enumerated are to be considered to be expressly stated in this disclosure.

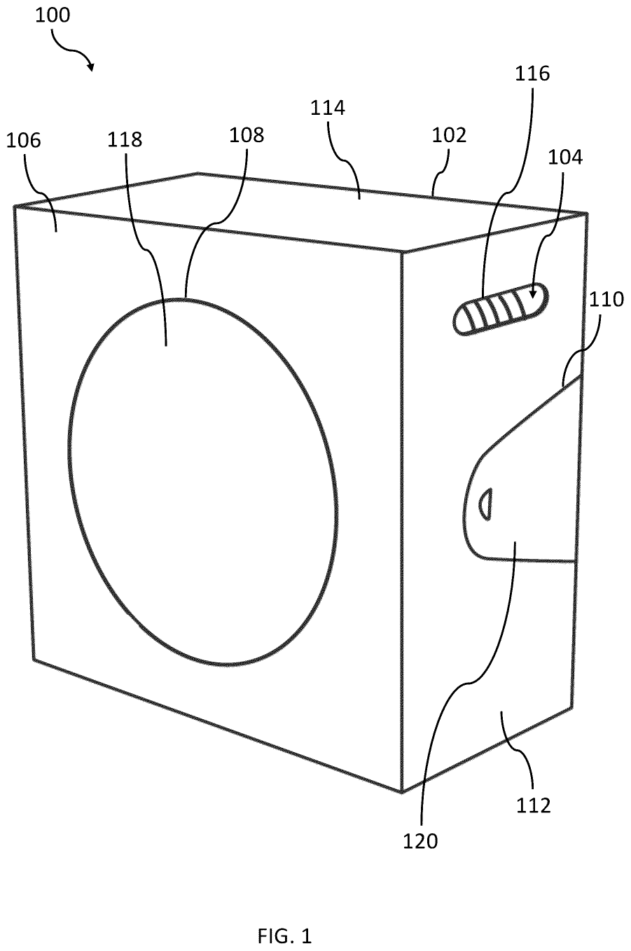

FIG. 1 illustrates a front perspective view of a system 100 for communications equipment installation in accordance with embodiments of the present disclosure. Referring to FIG. 1, the system 100 includes a container 102 that defines an interior space (indicated by arrow 104) and that includes a front side 106 and an opposing back side (not shown in FIG. 1) that at least partially encloses the interior space. The front side 106 defines an opening 108. The back side defines another opening 110. In this example, the opening 110 extends between the back side and another side 112 of the container 102. Only a portion of the opening 110 is visible in FIG. 1.

With continuing reference to FIG. 1, the container 102 includes a top side 114. The container 102 is generally cubical in shape in this example. However, it should be recognized that the container 102 may be any other suitable shape and size. In an example, for cable lengths between 0 and 500 feet, the container 102 can be approximately 17.5 inches×17.5 inches×9 inches. For cable lengths between about 501 feet and about 1500 feet, the container 102 can be approximately 21.5 inches×21.5 inches×11 inches. For cable lengths between about 1501 feet and about 3000 feet, the container can be approximately 25 inches×25 inches×12 inches. For cable lengths between about 3001 feet to about 5000 feet, the container can be approximately 27.5 inches×27.5 inches×14 inches. These examples can be suitable for a standard flat drop cable. If the cable size is smaller, a longer length of cable can be placed in the container 102. For example, Corning's ROC drop or Micro Drop cable can increase these numbers by 30% or more.

The container 102 may be made of any suitable material. In this example, the container 102 is made of paperboard, particularly cardboard. However, it should be recognized that any suitable lightweight material may be used for constructing the container 102.

An opening 116 is defined in the side 112 of the container 102. In this example, the opening 116 is generally oblong in shape for functioning as a handle. Also, the opening 116 is positioned near the top side 114. The container 102 also defines another opening (not shown) of the same or similar size, shape, and positioning on the side as the opening 116 such that these openings function as a pair of handles. As a result, a communication equipment service provider or technician can move the container 102 by use of the handles.

The opening 108 shown in FIG. 1 is covered by a removable cover 118. The removable cover 118 can function to assist with holding contents within the interior space 104 of the container 102. In this example, the removable cover 118 is a removable section of the container 102. Particularly, the removable cover 118 and the container 102 can be a single sheet of paper board that is formed into the shape of the container shown in FIG. 1 and other figures disclosed herein. Further, the removable section of the cover 118 can be defined in the front side 106 by perforations that provide the outside edges of the cover 118. Therefore, a person can tear open or otherwise separate the cover 118 at the perforations such that the interior space 104 of the container 102 is accessible. As described further herein, the interior space 104 can hold communications equipment to be installed by a service provider or technician.

Opening 110 can also be entirely, substantially, or at least partially covered by a removable cover 120 such that the interior space 104 can be accessible by the rear side of the container 102 and/or through side 112. Similar to the removable cover 118, the removable cover 120 can be a removable section of the container 102. Particularly, the removable cover 120 and the container 102 can be a single sheet of paper board. Further, the removable section of the cover 120 can be defined in the rear side (not shown in FIG. 1) and the side 112 by perforations that provide the outside edges of the cover 120. Therefore, a person can tear open or otherwise separate the cover 120 at the perforations such that the interior space 104 of the container 102 is accessible.

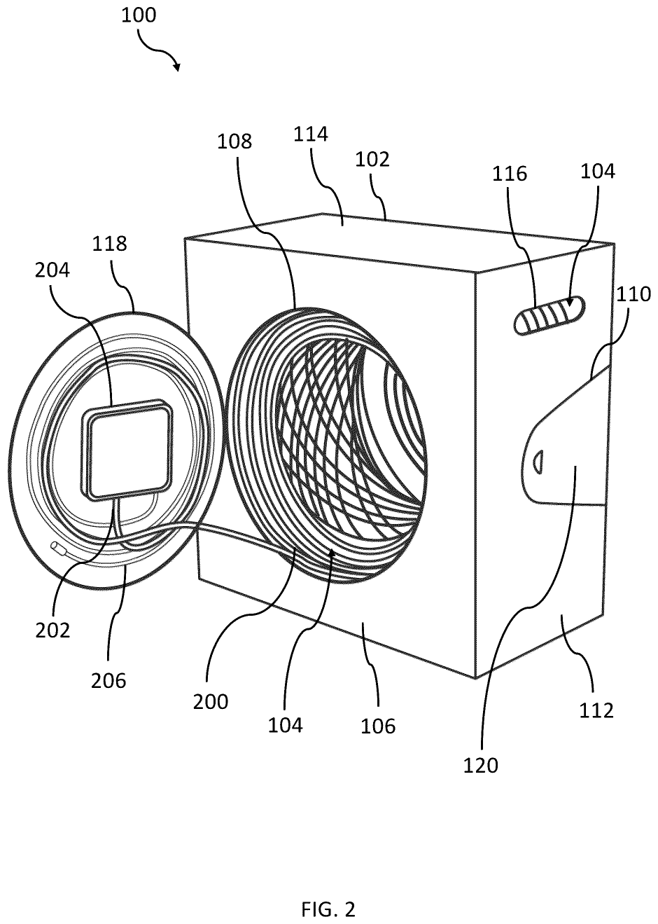

FIG. 2 illustrates another front perspective view of the container 102 shown in FIG. 1 with the cover 118 removed and positioned apart from the container 102 for access to the interior space 104. In this configuration with the cover 118 being removed as shown in FIG. 2, the interior space 104 and its contents are accessible. In this example, communications cable 200 can be viewed and accessed through the opening 108. The communications cable 200 is fiber optic cable, but it should be understood that the cable 200 may be any suitable communications cable. Further, in this example, the cable 200 is wound in a figure-eight configuration, but it should be understood that the cable 200 may be stored and held within the interior space 104 in any suitable configuration. Other communications equipment may be stored in the interior space aside from the cable 200.

Within continuing reference to FIG. 2, the cable 200 includes an end 202 positioned at a forward position. As shown in FIG. 2, the end 202 is removably affixed to the cover 118. As a result, when the cover 118 is removed then the end 202 is easily accessible by a service provider or technician. Further, the cable 200 is wound suitably (e.g., in a figure-eight configuration) such that when the end 202 is pulled out for installation of the cable 200, then the rest of the cable 200 can easily be removed from the container 102 with minimal resistance (e.g., without kinking).

The end 202 of the cable 200 can be affixed to the cover 118 in a suitable manner such that the end 202 can be easily removed from the cover 118 by the service provider or technician. In an example, the end 202 can be affixed to the cover 118 by one or more cable ties (also referred to as a “zip tie”). In another example, the end 202 can be affixed to the cover 118.

Apertures or holes utilized for holding a cable or NID may be formed into any suitable pattern. In an example, the pattern is shaped as a star design, which prevents tearing of the container. For attachment for example, the cable end 202 can be secured to the cover 118 using zip ties that are inserted from the inside, to the outside, and back in through the adjacent hole. Then it is pulled to the opposite side of the opening and pushed through the first hole from the inside to the outside and then pulled back into the inside via the adjacent hole. This is done to create an “X” pattern on the inside of the box. This may be repeated 2 times or any suitable number of ties for secure attachment. Subsequently, the NID or MST is laid on top of the “X” pattern. Finally, the zip ties are joined over the top of the NID or MST and pulled tight to secure it to the box. 1 or 2 zip ties may be utilized as it is fairly snug with even 1 and once it is sealed, it is inside the coil. Subsequently, the pulling end is terminated, then it is coiled and secured to the other size of the box in a similar fashion. If it is not terminated, then it may be exposed through the hole the assembler pulled from.

The system 100 also includes network access equipment 204 configured for operable connection to the end 202 of the cable 200. In this example, the network access equipment 204 is a network access point (NAP). Another cable 206 is also operably connected to the network access equipment 204. The cable 206 can be a fiber input/output (I/O) cable. Further, the cable 206 can be suitably affixed to the cover 118.

In an example of installation, the cover 118 can be removed or detached from covering the opening 108. Subsequently, the cover 118 along with the attached cable end 202, the network access equipment 204, and the cable 206 can be carried to a place of deployment at a building. At this location, the cable end 202, the network access equipment 204, and the cable 206 can be detached from the cover 118.

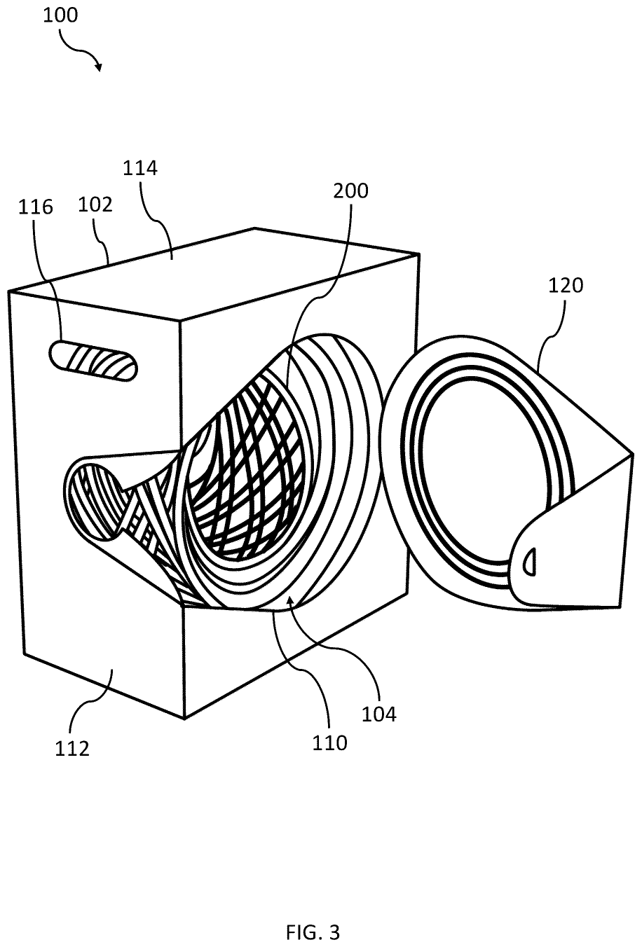

FIG. 3 illustrates a rear perspective view of the container 102 shown in FIG. 1 with the cover 120 removed and positioned apart from the container 102 for access to the interior space 104. In this configuration with the cover 120 being removed as shown in FIG. 3, the interior space 104 and its contents are accessible from the rear. In this example, the communications cable 200 can be viewed and accessed through the opening 108. Further, in this example, the cable 200 is wound in a figure-eight configuration, but it should be understood that the cable 200 may be stored and held within the interior space 104 in any suitable configuration. Other communications equipment may be stored in the interior space aside from the cable 200.

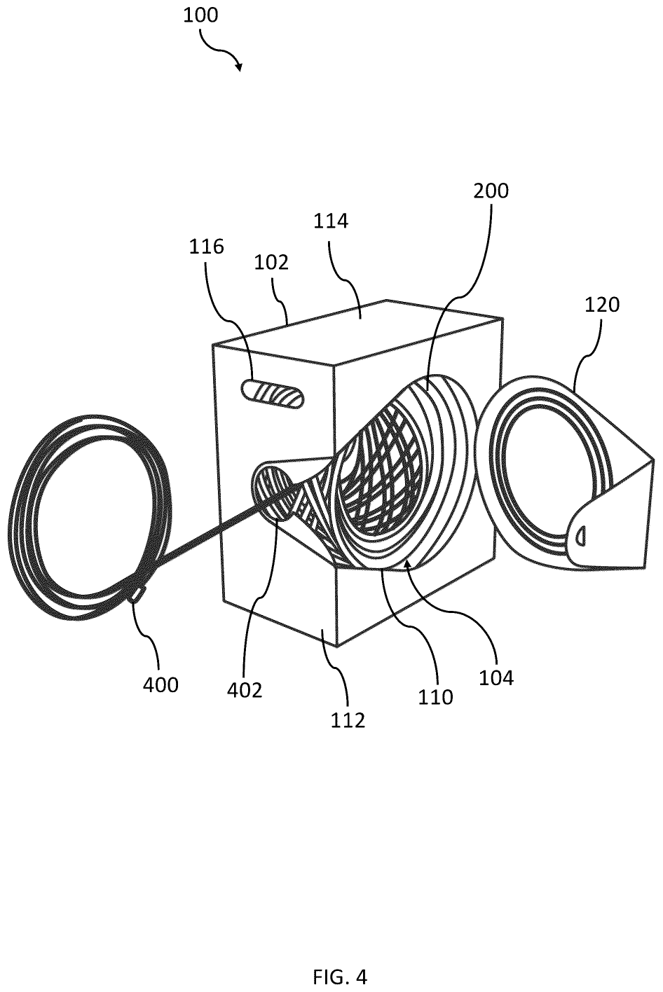

FIG. 4 illustrates another rear perspective view of the container 102 as shown in FIG. 3 except with an end 400 of the cable 200 extending through the opening 110. The end 400 of the cable 200 opposes the end 202 of the cable 200 shown in FIG. 2. Referring to FIG. 4, the end 400 extends through a portion 402 of the opening 110. By placing the cable 200 within the portion 402 of the opening 110, movement of the cable 200 is restricted as it is pulled by a service provider or technician out of the interior space 104 for installation.

With continuing reference to FIG. 4, it is noted that the end 400 of the cable 200 can be affixed to an interior surface 404 of the cover 120 while packaged. For example, the end 400 can be affixed to the cover 120 with one or more cable ties. Particularly, the end 400 can be coiled as shown in FIG. 4 and affixed to the cover 120 in this coiled configuration.

In accordance with embodiments, the system 100 can be assembled and inspected by qualified personnel for provision or sale to a service provider. In an example, an assembly method can include forming the container 102 with paperboard (e.g., cardboard). Further, the method can include winding the communications cable 200 and placing the communications cable 200 in the interior space 104 of the container 102. The method can also include placing the network access equipment 204 in the interior space 104 of the container 102. Further, the method can include testing operability of the communications cable 200 and the network access equipment 204.

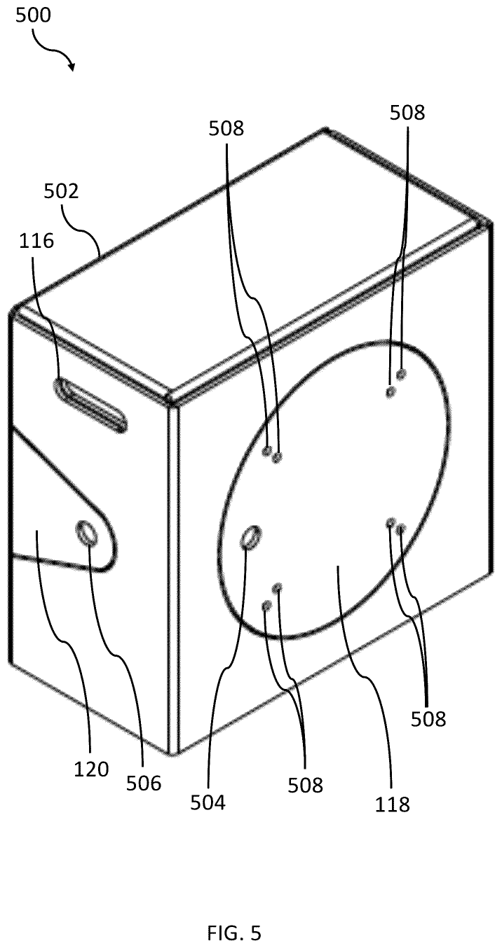

FIG. 5 illustrates a front perspective view of a system 500 for communications equipment installation in accordance with embodiments of the present disclosure. Referring to FIG. 5, the system 500 includes a container 502 similar to the container 102 of FIGS. 1-4. Particularly, the system 500 includes an opening 116 and covers 118 and 120. In this embodiment, covers 118 and 120 define openings 504 and 506, respectively, such that a service provider or technician can insert a finger to pull on the respective cover to detach it from the container 502. The cover 118 also defines multiple apertures 508 arranged, sized, and shaped for receiving cable ties for affixing the attached cable end 202, the network access equipment 204, and the cable 206 to the cover 118.

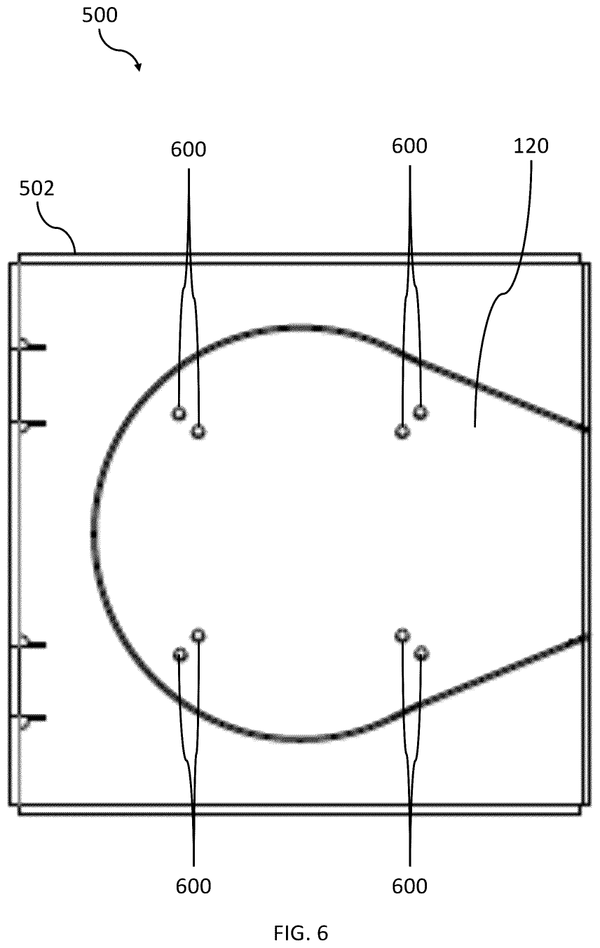

FIG. 6 illustrates a rear view of the system 500 shown in FIG. 5. Referring to FIG. 6, the cover 120 defines multiple apertures 600 arranged, sized, and shaped for receiving cable ties for affixing the cable end 400 to the cover 120.

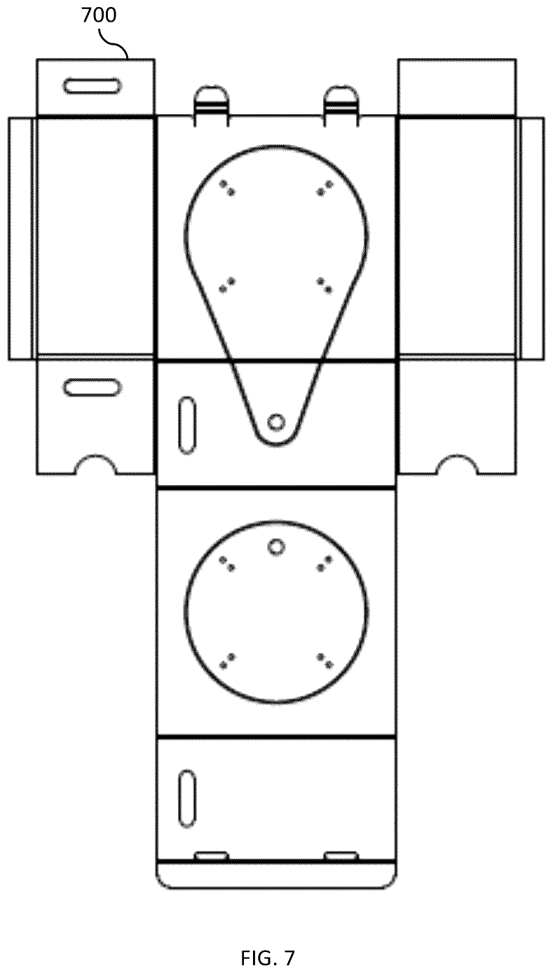

FIG. 7 illustrates a top view of a cardboard cutout 700 that can be folded to form the container 502 shown in FIGS. 5 and 6.

In an example application of the disclosed subject matter, a system as described herein can be provided as a factory certified, pre-connected optical network link in a box or container for providing connectivity from the NAP to the ONT/U. As a result, ease of installation is provided, and can be performed by a single service provider or technician. Additionally, the disclosed subject matter can use reel-less payoff for the fiber drop cables. The present disclosure can provide substantial savings in time and money while increasing reliability and optical performance. Further, the equipment can be certified. Certifying the link at the factory instead of in the field reduces installation time, equipment costs, and labor costs, while increasing reliability.

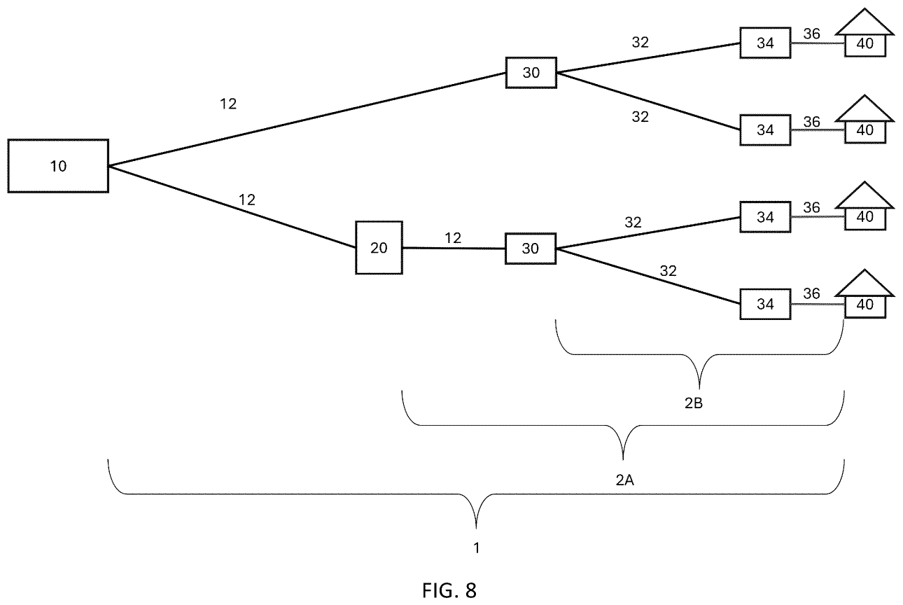

FIG. 8 illustrates a block diagram of an example optical distribution network where a system in accordance with embodiments of the present disclosure can be installed. Referring to FIG. 8, the optical distribution network includes an optical line terminal (OLT) at a central or headend office 10 with operable connection to a fiber distribution hub 20 and NAP 30 via optical feeder fiber 12. The fiber distribution hub 20 is operably connected to another NAP via optical feeder fiber 12. NAPs 30 are connected to network interface demarcation points 34 via fiber optic drop cable 32. Network interface demarcation points 34 are operably connected to subscriber homes 40 via fiber I/O cable 36. Systems in accordance with the presently disclosed subject matter can be used for installing the fiber optic drop cable 32, the network interface demarcation points 34, and the I/O cables 36 for connecting the homes 40 to NAPs 30.

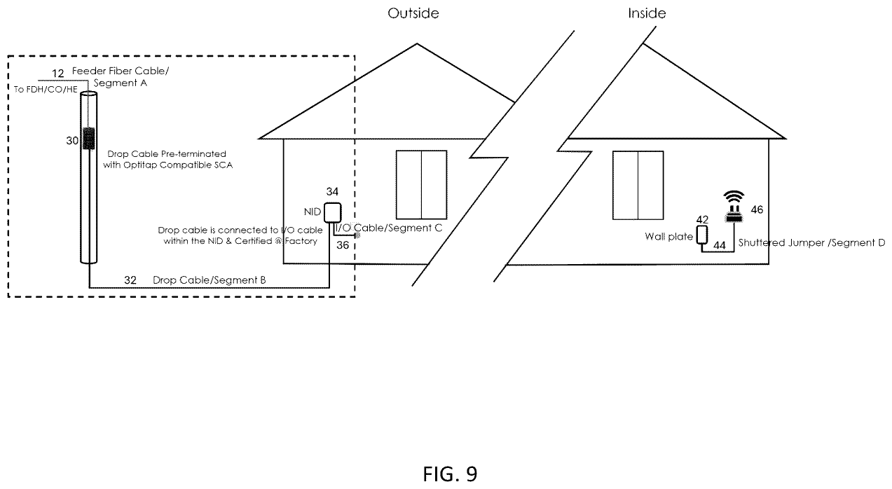

FIG. 9 illustrates a diagram depicting use of a system in accordance with embodiments for connecting a home to fiber-based Internet. Referring to FIG. 9, this figure shows the portion of the ODN that makes up a certified link and extends into the subscriber premises or home. Segment A 12 represents a starting point of the certified link. Segment B 32 represents the starting point of the certified link.

With continuing reference to FIG. 9, a feeder fiber cable 12 extends towards the home. The cable 12 is connected to a NAP 30. The NAP is operably connected to a drop cable 32, which is operably connected to a network interface demarcation point 34. The network interface demarcation point 34 is operably connected to a fiber I/O cable 36 for connection to equipment within the home. Also in FIG. 9, an optical network terminal/unit 46 is connected to an indoor wall plate via a fiber patch cable 44 with shuttered connectors.

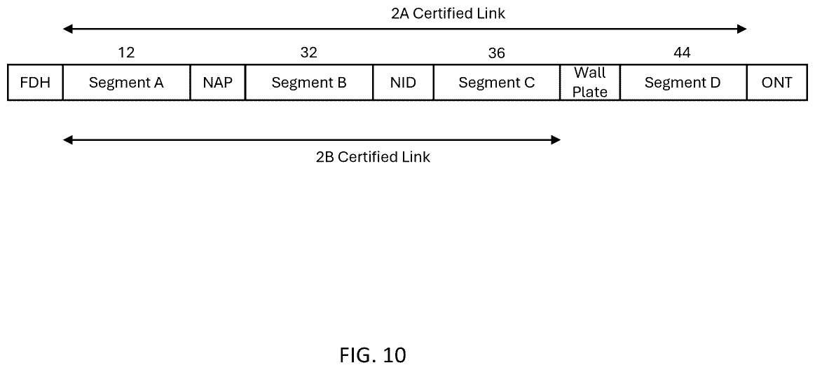

In an example application of the present disclosure, at a minimum the fiber drop cable 32 is preconnected either to a fiber I/O cable 36 via the NID 34 enclosure or another fiber drop cable 32 via a NAP 30. The fiber drop cable 32, fiber I/O cable 36 and NAP 30/NID 34 are preconnected and shipped with a wall plate 42, and fiber patch cable/jumper with shuttered adapters 44 inside a single customized box 50. The factory certification of the optical network link is performed while it is in the box and may include testing the link from the NAP 30 to the ONT 46 or from the NAP 30 to the wall plate 42. For example, FIG. 10 illustrates a diagram showing element of a link to be certified. This certification ensures optimal performance in the field. Second, the elements are secured within the customized box to ensure easy and quick access while reducing the possibility of damage during shipment. Third, the reel-less Fiber Drop Cable 32, NID 34, and I/O fiber jumper/cable can be rapidly removed from the box without kinking, twisting, or tangling. All of this can be performed by a single unskilled technician without using expensive tools, which results in faster, simpler, and more reliable installations.

Unless otherwise defined, all technical terms used herein have the same meaning as commonly understood by one of ordinary skill in the art to which this disclosure belongs.

While the embodiments have been described in connection with the various embodiments of the various figures, it is to be understood that other similar embodiments may be used, or modifications and additions may be made to the described embodiment for performing the same function without deviating therefrom. Therefore, the disclosed embodiments should not be limited to any single embodiment, but rather should be construed in breadth and scope in accordance with the appended claims.

1. A system for communications equipment installation, the system comprising:
a container that defines an interior space and that includes a first side and a second side that at least partially encloses the interior space, wherein the first side defines a first opening, and wherein the second side defines a second opening;
a first removable cover that at least partially covers the first opening;
a second removable cover that at least partially covers the second opening;
a communications cable including a first end and a second end, wherein the communications cable is positioned within the interior space such that the first end is positioned adjacent the first opening for access through the first opening; and
network access equipment configured for connection to the second end, wherein the network access equipment and/or the second end of the communications cable are removably affixed to the second removable cover such that the network access equipment and/or the second end of the communications cable are accessible when the second removable cover is removed from the second opening.

2. The system of claim 1, wherein the container, the first removable cover, and the second removable cover comprise paperboard.

3. The system of claim 1, wherein the first removable cover and the second removable cover are removable sections of the container, wherein the removable sections are defined by perforations formed in the container.

5. The system of claim 1, wherein the first side and the second side are opposing sides of the container.

6. The system of claim 1, wherein the container is substantially cubical in shape.

7. The system of claim 1, wherein the container includes a third side, and wherein the first opening extends between the first side and the third side of the container.

8. The system of claim 1, wherein the second opening is substantially circular in shape.

9. The system of claim 1, wherein the network access equipment comprises a network access point.

10. The system of claim 1, wherein the communications cable comprises fiber optic cable.

11. The system of claim 1, wherein the communications cable is wound.

12. The system of claim 1, wherein the communications cable is wound in a figure-eight configuration.

13. A method for communications equipment deployment, the method comprising:
providing a container that defines an interior space and that includes a first side and a second side that at least partially encloses the interior space, wherein the first side defines a first opening, and wherein the second side defines a second opening, wherein a first removable cover at least partially covers the first opening, wherein a second removable cover at least partially covers the second opening, wherein a communications cable including a first end and a second end is positioned within the interior space such that the first end is positioned adjacent the first opening for access through the first opening, and wherein the network access equipment and/or the second end of the communications cable are removably affixed to the second removable cover such that the network access equipment and/or the second end of the communications cable are accessible when the second removable cover is removed from the second opening;
removing the first removable covering for access of the first end of the communications cable through the first opening; and
removing the second removable covering for access of the network access equipment and/or the second end of the communications cable through the second opening.

14. The method of claim 13, wherein the container, the first removable cover, and the second removable cover comprise paperboard.

15. The method of claim 13, wherein the first removable cover and the second removable cover are removable sections of the container, wherein the removable sections are defined by perforations formed in the container.

16. The method of claim 13, wherein the first side and the second side are opposing sides of the container.

17. The method of claim 13, wherein the container is substantially cubical in shape.

18. The method of claim 13, wherein the container includes a third side, and wherein the first opening extends between the first side and the third side of the container.

19. The method of claim 13, wherein the second opening is substantially circular in shape.

20. The method of claim 13, wherein the network access equipment comprises a network access point.

21. The method of claim 13, wherein the communications cable comprises fiber optic cable.

22. The method of claim 13, wherein the communications cable is wound.

23. The method of claim 13, wherein the communications cable is wound in a figure-eight configuration.

24. The method of claim 13, further comprising pulling the first end of the communications cable through the first opening to remove at least a portion of the communications cable from the interior space of the container.

25. The method of claim 13, further comprising pulling the second end of the communications cable through the to remove at least a portion of the communications cable from the interior space of the container.

26. The method of claim 13, further comprising forming the container with paperboard.

27. The method of claim 13, further comprising winding the communications cable and placing the communications cable in the interior space of the container.

28. The method of claim 27, further comprising placing the network access equipment in the interior space of the container.

29. The method of claim 13, further comprising testing operability of the communications cable and the network access equipment.
